(19) United States
(12) Patent Application Publication
(10) Pub. No.: US 2006/0136201 A1
(43) Pub. Date: Jun. 22, 2006

(54) Hands-free push-to-talk radio

(75) Inventors: Daniel J. Landron, Margate, FL (US); Ali Behboodian, Natick, MA (US); Chin P. Wong, Parkland, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/020,423

(22) Filed: Dec. 22, 2004

(51) Int. Cl. G10L 11/06

(52) U.S. Cl. 704/215

(57) ABSTRACT

A hands-free digital push-to-talk device (102) includes a digital background noise suppressor (302), a digital voice activity detector (304), an audio buffer (306), as well as a decision handler (308), embedded inside the device's (102) digital signal processor (222). Audio is buffered until the decision handler (308) determines that speech is present on an audio stream fed to the voice activity detector (304). The decision handler (308) makes the decision by assigning weighted values to each voice activity detector (304) determination, the weighted value varying depending on the state of the device (102) and temporal distance from the present time.

### BACKGROUND OF THE INVENTION

### FIELD OF THE INVENTION

The present invention relates generally to push-to-talk radios, and more particularly relates to hands-free operation of the push-to-talk radio function.

### BACKGROUND OF THE INVENTION

A number of mobile, or wireless, communication systems are in widespread use today. These systems provide a wide variety of communication modes. Possibly the most well known is the cellular telephone communication system. Other systems in slightly less widespread use include trunked radio systems, which are most well known for being used by public safety and law enforcement agencies. These latter communication systems provide what has been referred to as “dispatch” communication.

Dispatch communication is half-duplex communication, where, when one person is speaking, the other(s) can only listen. This differs from telephone communication, which is full duplex, and both parties in a call can speak and listen simultaneously. Dispatch communication has an advantage in that call set-up time is very short.

However, to operate a half-duplex phone, a user must press a button to begin talking to the other party or parties and then release the button to be able to listen to the other party. This procedure is referred to as “push-to-talk” (“PTT”) and can be inconvenient when a user's hands are needed for another use, such as operating a motor vehicle, while a conversation is ongoing.

Over the past few years, there has been an increasing market demand for totally hands-free communication devices. For cellular phones, there are voice activated calling functions and duplex speakerphones that allow full two-way verbal communication without the need for tactile participation. However, for PTT devices, there is no similar reliable solution for hands-free communication.

One attempt at providing hands-free communication ability in a PTT device is a headset that attaches to the device. The headset itself typically includes analog circuits that detect speech. However, one problem is the headset is bulky. Further, another problem is the headset is an extra piece of hardware that must now be used in conjunction with the device itself. Still further, another problem is the headset requires an extra power source to power the headset.

Therefore a need exists to overcome the problems with the prior art as discussed above.

### SUMMARY OF THE INVENTION

Briefly, in accordance with the present invention, disclosed is a system for wirelessly communicating in a dispatch mode without the need for a user to push a button to transmit or receive voice signals. The system includes an audio input, an audio buffer coupled to the audio input, a transmit switch coupled to the audio buffer, a voice activity detector coupled to the audio input, and a decision handler coupled to the voice activity detector, the audio buffer, and the transmit switch. The voice activity detector receives an audio signal from the audio input and outputs a value to the decision handler. The value from the voice activity detector represents a probability that the audio signal is a voice signal. The decision handler, based on a current and at least one past value output from the voice activity detector, sends a decision signal that causes the transmit switch to open and the audio buffer to transmit the audio signal if the decision handler computes a probability of speech higher than the speech threshold.

In one embodiment, the present invention includes a noise suppressor located between the audio input and the audio buffer and between the audio input and the voice activity detector. The noise suppressor eliminates noise from the audio signal.

In another embodiment of the present invention, the voice activity detector outputs a value representative of whether speech is present in the audio signal based on a plurality of audio samples of the audio signal.

In yet another embodiment of the present invention, the audio buffer transmits the audio signal with a time delay. At least some time delay continues the entire time the audio is being transmitted.

In still another embodiment of the present invention, the decision handler includes a threshold enable value, a threshold disable value, and a probability of speech value. The probability of speech value is determined from a plurality of values received from the voice activity detector. The switch is placed in an open state if the probability of speech value is greater that the threshold enable value and the switch is placed in a closed state if the probability of speech value is less than the threshold disable value.

In one more embodiment of the present invention, the decision handler further includes a weighting factor that is multiplied by each of the values received from the voice activity detector. The weighting factor can have a different value for each value received from the voice activity detector.

In yet another embodiment of the present invention, each of the threshold enable and threshold disable values has a unique value for each of a transmit state and an idle state of the device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an overall system diagram illustrating one embodiment of a mobile communication network in accordance with the present invention.

FIG. 2 is a hardware block diagram illustrating one embodiment of a wireless device in accordance with the present invention.

FIG. 3 is a block diagram of the functional software components of the digital signal processor shown in FIG. 2, in accordance with the present invention.

FIG. 4 is a block diagram illustrating the four states traversed by a subscriber unit in accordance with the present invention.

FIG. 5 is a flow diagram of a wireless device algorithm for hands-free transitioning from an idle state to a transmit state in accordance with the present invention.

FIG. 6 is a flow diagram of a wireless device algorithm for hands-free transitioning from a transmit state to a listen state in accordance with the present invention.

FIG. 7 is a graph showing a ramp rate for a weighting constant K over time in accordance with the present invention.

FIG. 8 is a graph showing a second ramp rate for a weighting constant K over time in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by achieving a totally hands-free digital PTT system by using a digital background Noise Suppressor (NS), a digital Voice Activity Detector (VAD), an Audio Buffer (AB), as well as a Decision Handler (DH), and embedding this functionality inside the Subscriber Unit's (SU) Digital Signal Processor (DSP). Digital VAD and NS ensure a high accuracy of speech detection and provide hands-free two-way communication with a PTT device. Since all processing is done with existing hardware and with software running on the device itself, there is no need for extra hardware to support the feature. Additionally, if a user wishes to utilize a headset, the solution is not limited to a certain type of headset, but is compatible with all powered and non-powered headsets.

Described now is an exemplary hardware platform according to an exemplary embodiment of the present invention.

System Diagram

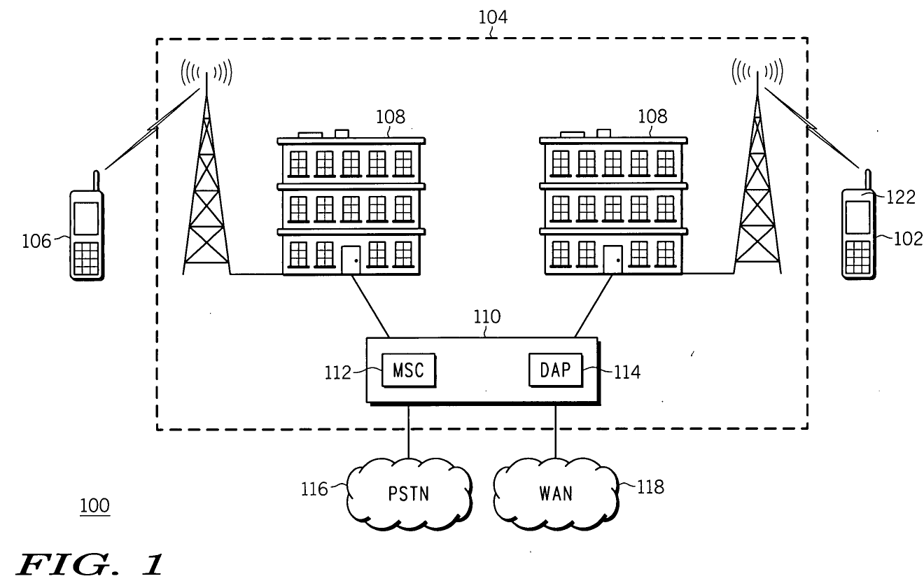

Referring now to FIG. 1, there is shown a system diagram 100 of a wireless communication system in accordance with the invention. A first wireless device, or “subscriber unit”, 102 is used by a first user. The first subscriber unit communicates with a communication system infrastructure 104 to link to a second subscriber unit 106. The communication system infrastructure 104 includes base stations 108 which establish service areas in the vicinity of the base station to support wireless mobile communication, as is known in the art.

The base stations 108 communicate with a central office 110 which includes call processing equipment for facilitating communication among subscriber units and between subscriber units and parties outside the communication system infrastructure, such as a mobile switching center 112 for processing mobile telephony calls, and a dispatch application processor 114 for processing dispatch or half duplex communication. Dispatch calling includes both one-to-one “private” calling and one-to-many “group” calling.

The central office 110 is further operably connected to a public switched telephone network (PSTN) 116 to connect calls between the subscriber units within the communication system infrastructure and telephone equipment outside the system 100. Furthermore, the central office 110 provides connectivity to a wide area data network (WAN) 118, which may include connectivity to the Internet.

Subscriber Unit

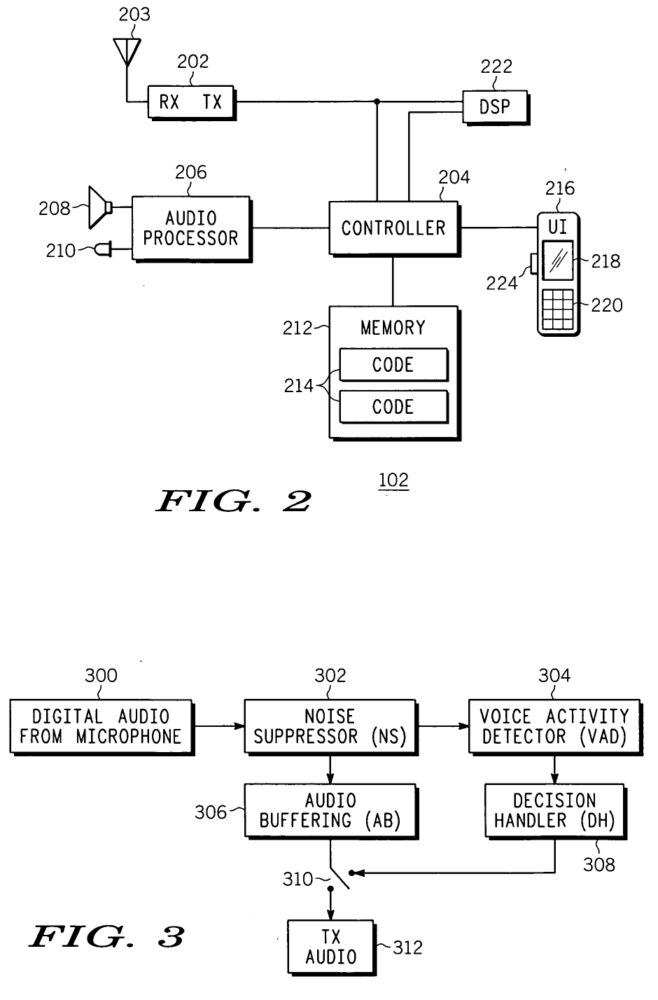

Referring now to FIG. 2, there is shown a schematic block diagram of a subscriber unit 102 designed for use in accordance with the invention. The subscriber unit 102 comprises a radio frequency transceiver 202 for communicating with the communication system infrastructure equipment 104, or directly to another subscriber unit 106, via radio frequency signals over an antenna 203. The operation of the subscriber unit and the transceiver is controlled by a controller 204. The subscriber unit 102 also comprises an audio processor 206 which processes audio signals received from the transceiver to be played over a speaker 208, and it processes signals received from a microphone 210 to be delivered to the digital signal processor 222 and/or the transceiver 202. In one embodiment of the present invention, the audio processor 206 includes a digital to analog and/or an analog to digital converter (not shown). However, the converter can be a separate module and be located at other locations within the subscriber unit 102.

The controller 204 operates according to instruction code disposed in a memory 212 of the subscriber unit. Various modules 214 of code are used for instantiating various functions. To allow the user to operate the subscriber unit 102, and receive information from the subscriber unit 102, the subscriber unit 102 comprises a user interface 216, including a display 218, and a keypad 220. Furthermore, the subscriber unit 102 is provided with a PTT button 224 for placing the subscriber unit 102 into and out of talk mode.

Digital Signal Processor

The subscriber unit 102 also includes a digital signal processor (“DSP”) 222 that is coupled to the transceiver 202, the audio processor 206, and is under the control of the controller 204. It should be noted that the DSP 222 can be replaced with a specialized or a general purpose processor. The DSP 222 receives digital voice signals from the audio processor 206.

The functionality of the DSP 222, as will be explained below, may be accomplished through hardware, software, or a combination thereof. The computer instructions may be stored in a software module 214 in memory 212, some other memory storage device (not shown), or within a memory in the DSP 222 itself.

Noise Suppressor

Referring now to FIG. 3, the main functional blocks of the DSP 222 are shown. The digital audio signal 300 is fed to a noise suppressor (“NS”) 302. Noise suppressors are known in the art and function to eliminate or reduce the background noise in an audio stream. Any noise suppressor can be used as long as it reduces the level of background noise.

Voice Activity Detector

The noise suppressed audio signal is then fed to a voice activity detector (VAD) 304 and an audio buffer (AB) 306. A VAD is a device or algorithm that can differentiate speech from other sounds. A VAD can be implemented in hardware and/or software. Examples of factors that are considered in identifying speech characteristics are sound pitch, energy level, and harmonics. One teaching of a VAD is the commonly assigned U.S. Pat. No. 6,157,906, issued on Dec. 5, 2000, entitled “Method for Detecting Speech in a Vocoded Signal,” and is hereby incorporated by reference in its entirety. The VAD 304 will give a speech/no speech decision based on N audio samples (where N depends on the type of VAD used.) In one embodiment of the present invention, the VAD 304 outputs a value that ranges from zero (0) to one (1) depending on the certainty that the audio signal input to the VAD 304 contains speech components, where one (1) is the most likely and zero (0) is the least likely.

Audio Buffer

The AB 306 buffers the audio received from the NS 302. The length of time T that can be buffered can vary from zero (0) msec to I msec, where the variable “I” can range from any value greater than zero (0) to infinity. The variable T will be set to cover the expected delay between the time that speech begins until the time a transmit channel in the transceiver 202 is open. The lower limit of zero (0) msec is an ideal condition in which there is zero network delay and zero (0) VAD 304 delay. The upper limit of I msec is limited by the memory capacity of the buffer. As will be explained below, the buffered audio in the AB 306 will be transmitted. While the AB 306 is transmitting the buffered audio, the AB 306 will continue to buffer new audio. Therefore, the transmission will be a continuously buffered audio signal.

Decision Handler

Because the VAD 304 may not be 100% accurate, the output of the VAD 304 is fed to a decision handler (“DH”) 308. The DH 308 adds another layer of filtering and decides when a stream of audio is to be transmitted and when audio already being transmitted should stop being transmitted because speech is no longer present in the signal. The DH 308 functions by windowing the last N VAD 304 decisions, where N must be set empirically to determine the best performance. In one embodiment, the DH 308 looks for a window containing a minimum number of “1 s” output from the VAD 304 before transmission will start. Any window can be used and even different windows can be used when generating a start transmit decision or a stop transmit decision. Additionally, the DH 308 can be set to look for outputs of the VAD 304 that range in value depending on the VAD 304 being used and the specifics of the state of the subscriber unit 102.

All of the DH 308 parameters will be optimized for two states of operation: transmit start and transmit stop. For the transmit start, the DH 308 should generate reliable and fast triggers while not being fooled by false positives from the VAD 304. For transmit stop, the DH 308 should take into account short gaps of silence during speech without dropping the transmit channel while still generating an accurate end of transmit decision.

A Probability of Speech (“PoS”) value is calculated from the windowed VAD 304 decisions. The PoS value is then compared to a threshold enable value, Th_{enable}, to determine whether to enable transmission if the subscriber unit 102 isn't currently transmitting. To enable transmission, the DH 308 marks the buffered audio in the AB for transmission from the marked point on. The DH 308 then closes the switch 310, or places the switch 310 in a transmit state and the buffered signal is then sent to a transmitter 312. Alternatively, if the subscriber unit 102 is currently transmitting, the PoS value is compared with a threshold disable value, Th_{disable}, to disable transmission. If the PoS value is less than the Th_{disable} value, the switch 310 is placed into a non-transmit state. In one embodiment, the values Th_{enable} and Th_{disable} have a range of 0-1, and their actual value can be set dynamically depending on the environment and the current state of the subscriber unit 102 to create accurate decisions.

The PoS value is calculated with the following formula:

$$M {\sum }_{i = 1}^{N} {K}_{i} \cdot {VAD}_{i}$$

where M is a normalization factor, K is a weighting factor, and i is the index number for each VAD decision and each i represents a different time point. The value of K changes depending on the current state of the subscriber unit 102 and with each sample in temporal relation to the present time. For instance, when the DH 308 is windowing output values from the VAD 304, the output values further back in time will receive a lesser weighting factor than those that are nearest in a temporal distance, i.e., closer to the present time. The difference in the K values from present to past time points is called the “ramp” rate.

The graph in FIG. 7 shows the value of K versus time, where the leftmost point-in-time, T₁ is the closest to the present time and T₃ is the furthest past point-in-time. As can be seen, the difference between the K values, or “envelope” 700 falls as the time points get further away from the present time. This difference defines the ramp rate. Comparing the graph in FIG. 7 to that in FIG. 8, it can be seen that the ramp rate 800 in FIG. 8 is much steeper than that of FIG. 7. It is important to note that the K values shown in FIGS. 7 and 8 are exemplary only. Other K graphs including increasing over time, decreasing over time, flat, parabolic, and pulsed are within the true scope and spirit of the present invention.

If the PoS value exceeds the Th_{enable} value, the time point in the audio stream buffered in the AB 306 is marked for transmission start and the DH 308 opens a switch 310 to begin broadcasting the audio signal, starting at the marked time point. The higher the value of K, the quicker the PoS value will exceed the Th_{enable} value. As will be explained below, the ramp rate of FIG. 7 is desirable when the presence of speech in the audio stream is less likely or not anticipated and the steeper ramp rate of FIG. 8 will be desirable when speech is expected, such as during an ongoing conversation.

Subscriber Unit Operational States

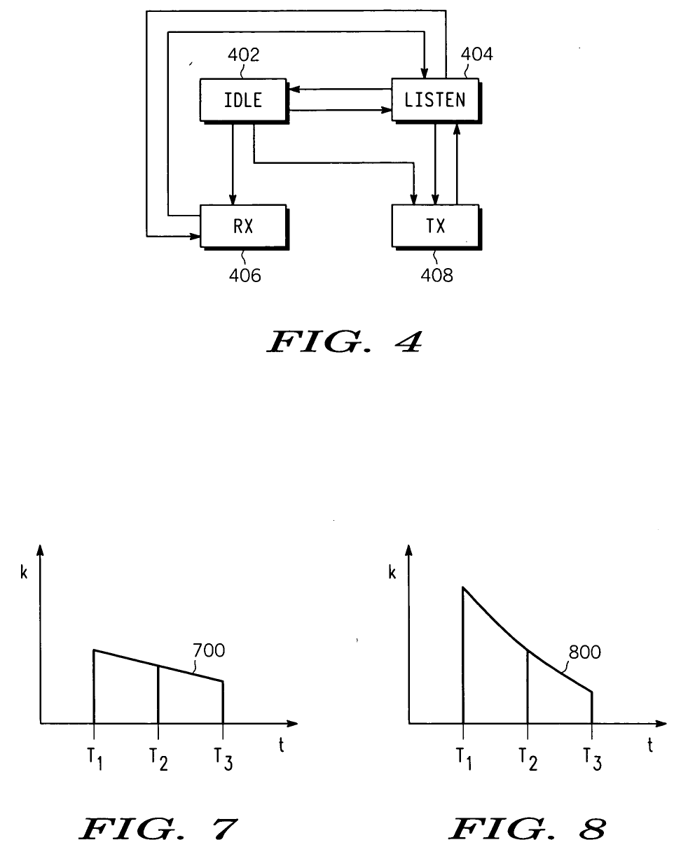

FIG. 4 is a state diagram showing four operational states of the present invention. The states are 1) idle 402, 2) transmit 408, 3) receive 406, and 4) listen 404. The idle state 402 is when the subscriber unit 102 is not actively engaged in a PTT call. The transmit state 408 is when the subscriber unit 102 is transmitting audio to another subscriber unit 106, or to the communication system infrastructure 104. The receive state 406 is when the subscriber unit 102 is receiving audio from another user. The listen state 404 is when the subscriber unit 102 is running the hands-free PTT algorithm to determine whether to enter the transmit state 408 or not.

When in the idle state 402, the subscriber unit 102 can transition into any of the other three states. Table 1 below shows the steps for transitioning into one of these states.

TABLE 1

| State Description | The IDLE state 402 is when the subscriber unit 102 |
|---|---|
| | is not actively in a PTT call |
| State Transition | To: LISTEN 404 |
| | Action 1: Through voice recognition, another user |
| | is called. |
| | Action 2: User actively selects to go to the listen |
| | state 404 through a user interface. |
| State Transition | To: TRANSMIT 408 |
| | Action: User presses the PTT button to call remote |
| | user. |
| State Transition | To: RECEIVE 406 |
| | Action: A remote user PTT calls the subscriber unit |
| | 102. |

To transition into the listen state 404, the subscriber unit 102 can be voice recognition enabled, so that a user can verbally instruct the subscriber unit 102 to call another user and then enter the listen state 404. Alternatively, the user can actively select the listen state 404 through use of the user interface 216 on the subscriber unit 102. To enter the transmit state 408, a user can press the PTT button 224 to call a remote user. Finally, Table 1 shows that the subscriber unit 102 will enter the receive state 406 when a remote user calls the subscriber unit 102 using the PTT feature.

Looking again to the state diagram of FIG. 4, when the subscriber unit 102 is in the transmit state 408, it can transition only to the listen state 404. Referring now to Table 2, two methods are shown for transitioning from transmit to listen.

TABLE 2

| | |
|---|---|
| State Description | The TRANSMIT 408 state is when the subscriber unit |
| | is transmitting audio to another user. |
| State Transition | To: LISTEN 404 |
| | Action 1: The hands-free PTT algorithm determines |
| | that speech is no longer present in the audio stream. |
| | Action 2: The user presses a button to stop |
| | transmitting. |

The first method is for the hands-free PTT algorithm to interpret the audio input to the subscriber unit and determine that speech is no longer present on the audio stream. This is accomplished, as described above, when the VAD 304 determines that speech is not present in the audio input stream and the DH 308 determines that the PoS value does not exceed the Th_{disable} value. If either occurs, the subscriber unit will enter the listen state 404. The second method for transitioning from transmit 408 to listen 404 is for the user to utilize the user interface 216 on the subscriber unit 102 to manually place the subscriber unit into the listen state 404.

As shown in FIG. 4, when in the receive state 406, the subscriber unit can only transition to the listen state 404. Referring now to Table 3, the method for transitioning from receive 406 to listen 404 is shown. The subscriber unit goes into the listen state 404 as soon as the remote user stops transmitting audio.

TABLE 3

| | |
|---|---|
| State Description | The RECEIVE state 406 is when the subscriber unit is |
| | receiving audio from another user. |
| State Transition | To: LISTEN 404 |
| | Action: The remote user stops transmitting. |

The final state is the listen state 404. Once in the listen state 404, as described in the preceding paragraphs, the subscriber unit interprets the audio input to the subscriber unit and determines whether speech is present on the audio stream. From the listen state 404, as can be seen in FIG. 4, the subscriber unit can go to any of the other three possible states. The methods for transitioning are listed in Table 4 below.

It should be noted at this point that the listen function can be tied to two different operation states of the subscriber unit 102: the idle operation state and the “hang time” operation state. The first is when the subscriber unit is not actively transmitting speech and does not have any network resources for a call. In this state, the subscriber unit is listening for audible noise that may be speech but the threshold will be higher to differentiate random, isolated, or background noise from that that is actual speech. Additionally or alternatively, the K value ramp rate may be slower or less steep, meaning that the K value for the present time does not have a great deal of amplitude, preventing the PoS value from easily increasing past the Th_{enable} value.

The second state is where the subscriber unit 102 is already in a PTT call and has the network resources allocated for it. In the second state, pauses between words or sentences is expected. There should therefore be an easier test, or lower threshold, to determine if the next sound is a word or not. In one embodiment of the present invention, when in this second state, the subscriber unit utilizes a “hang timer” that is a predefined period of time that begins after the last word is transmitted. For instance, the “hang time” could be 6 seconds. During the hang time, the subscriber unit remains in its current state with the lower Th_{enable} value. After the expiration of the hang time, the subscriber unit will return to the idle state 402. Additionally or alternatively, the K value will be higher or the ramp rate will be steep during the hang time. The steeper the value, the quicker the Pos value will exceed the Th_{enable} value triggering the DH 308 to set a marker on the buffered audio stream within the AB 306 and start the transmission of audio.

TABLE 4

| State Description | The LISTEN state 404 is when the subscriber unit 102 |
|---|---|
| | is running the hands-free PTT algorithm to determine |
| | whether to start transmitting or not. Alternatively, it |
| | can be tied to the hang timer so that during the hang |
| | time, the subscriber unit is listening for speech. |
| State Transition | To: IDLE 402 |
| | Action 1: The hang timer expires. |
| | Action 2: User actively cancels the listen state 404 |
| | through a user interface. |
| State Transition | To: TRANSMIT 408 |
| | Action 1: The hands-free PTT algorithm determines |
| | that speech is present in the audio stream. |
| | Action 2: User presses the PTT button to call remote |
| | user. |
| State Transition | To: RECEIVE 406 |
| | Action: A remote user PTT calls the subscriber unit |
| | 102. |

As shown in Table 4, from the listen state 404, the subscriber unit can transition to the idle state 402 through two methods. The first is the expiration of the hang time, as described above. The second method is for the user to cancel the listen operation through use of a user interface 216.

To transition to the transmit stage, two methods are available. The first is for the hands-free PTT algorithm to determine the presence of speech in the input audio stream. More specifically, if the VAD 304 determines that speech is present, and the DH 308 determines that the PoS value exceeds the Th_{enable} value, the subscriber unit will enter the transmit state 408. The second method is for the user to press the PTT button 224 on the subscriber unit 102.

Finally, to transition from the listen state 404 to the receive state 406, a remote user simply pushes his PTT button to call the subscriber unit 102.

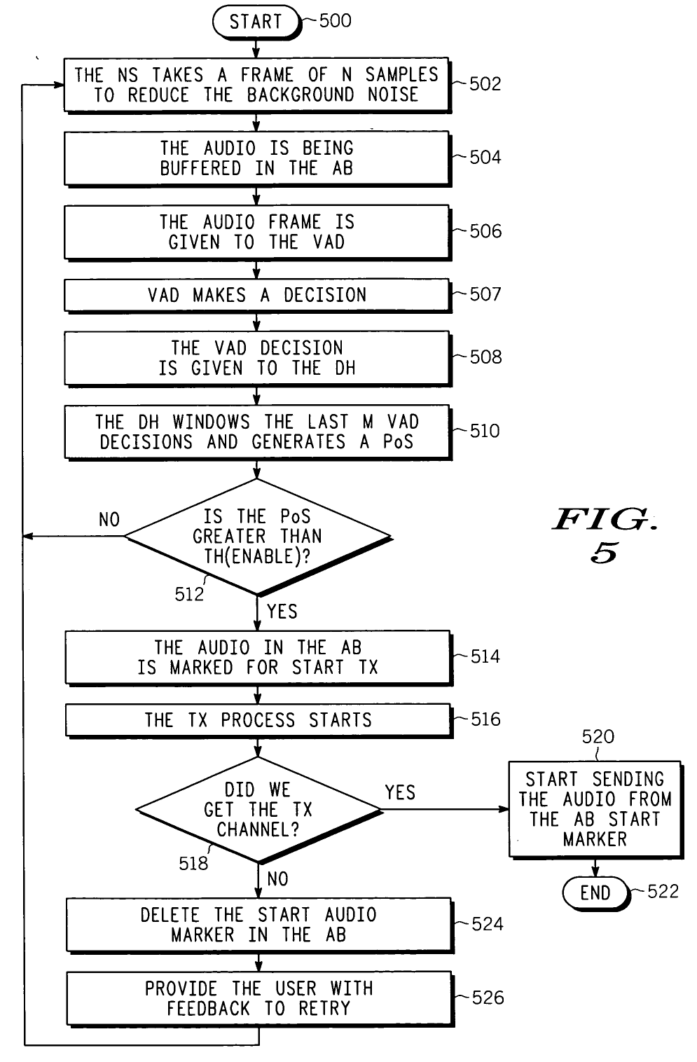

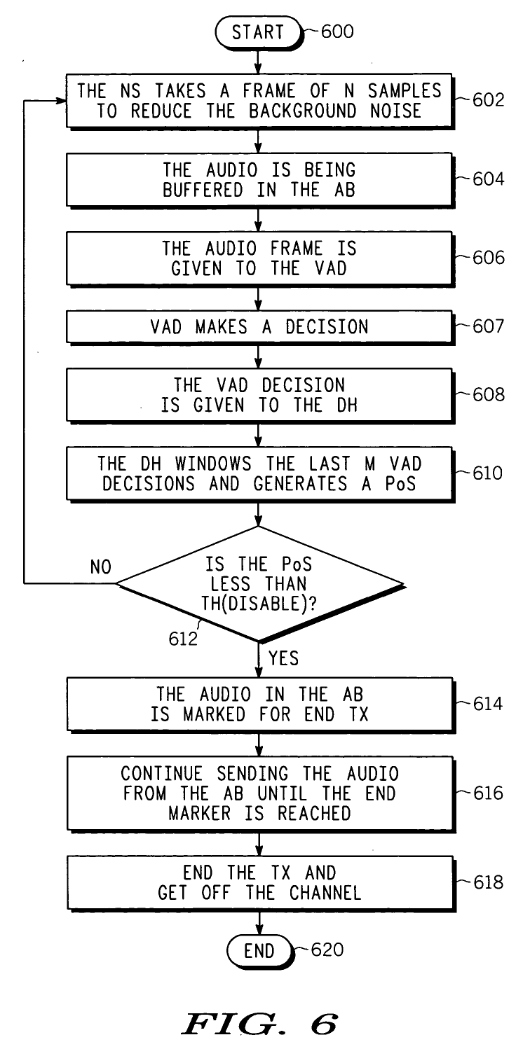

FIGS. 5 and 6 show flow diagrams describing typical usage scenarios for the present invention. The flow diagram of FIG. 5 describes the case in which the current state is listen 404 and it transitions to the transmit state 408. The flow begins at step 500 and immediately proceeds to step 502. In the first step 502, the noise suppressor 320 takes a frame of N samples or audio from the audio input. In the second step 504, the audio stream is then fed to and buffered in the audio buffer 306. At a subsequent point in time, or simultaneously with the buffering, the audio frame is given to the VAD 304 in the third step 506. In the next step 507, the VAD 304 makes a decision based on the audio frame. In step 508, the VAD decision is passed to the DH 308. The DH 308 windows the last M VAD decision and generates a PoS value in the next step 510. The PoS value is then compared to the Th_{enable} value in step 512. If the PoS value is greater than the Th_{enable} value, the flow moves to step 514, where the audio in the AB 306 is marked for transmit start and buffering continues. The process of negotiating a transmission channel is started in the next step 516. Next, in step 518, an inquiry is made as to whether a transmission channel was properly opened. If the channel is properly accessed, transmission of the audio, starting from the marker, begins in step 520 and the flow ends at step 522 once transmission is complete. If, however, no transmission channel is available or is not properly accessed, the start audio marker is deleted in the AB 306 in step 524. The user is provided with feedback regarding the failed transmission in step 526 and is notified that a second attempt is necessary. The flow then returns to step 502. Similarly, if, at step 512, the PoS value is not greater than the Th_{enable} value, the flow returns to step 502 where the NS 302 takes a new frame of N samples and the process starts again.

FIG. 6 is a flow diagram illustrating the steps for transitioning from a transmit state 408 to a listen state 404. The flow begins at step 600 and immediately proceeds to step 602. In step 602, the noise suppressor 320 takes a frame of N samples or audio. The N samples are used to reduce background noise in the audio stream. The audio is then fed to and buffered, in step 604, in audio buffer 306. At a subsequent point in time, or simultaneously with the buffering, the audio frame is given to the VAD 304 in step 606. The VAD 304 then makes a decision based on the audio frame, in step 607. In step 608, the VAD decision is passed to the DH 308. The DH 308 windows the last M VAD decision and generates a PoS value in step 610. The PoS value is then compared to the Th_{disable} value in step 512. If the PoS value is lesser than the Th_{disable} value, the flow moves to step 614, where, because the audio is buffered, the audio in the AB 306 is marked for end of transmission. The buffered audio continues being sent from the AB 306 until the end of marker point is reached, in step 616. Transmission is then ended and the transmission channel is released, in step 618 and the flow ends in step 620. Alternatively, if, at step 612, the PoS value is greater than the Th_{disable} value, the flow returns to step 602 where the NS 302 takes a new frame of N samples and the process continues.

Conclusion

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A wireless communication device, comprising:
an audio input;
an audio buffer coupled to the audio input;
a transmit switch coupled to the audio buffer;
a voice activity detector coupled to the audio input; and
a decision handler coupled to the voice activity detector, the audio buffer, and the transmit switch,
wherein the voice activity detector receives an audio signal from the audio input and outputs a value to the decision handler, the value representing a probability that the audio signal is a voice signal, and the decision handler, based on a current and at least one past value output from the voice activity detector, sends a decision signal that causes the transmit switch to close and the audio buffer to transmit the audio signal therefrom.

2. The wireless communication device according to claim 1, further comprising:
at least one of (i) a noise suppressor provided between the audio input and the audio buffer and (ii) a noise suppressor provided between the audio input and the voice activity detector, the noise suppressor for eliminating noise from the audio signal.

3. The wireless communication device according to claim 1, wherein the voice activity detector outputs the value based on a plurality of audio samples of the audio signal.

4. The wireless communication device according to claim 1, wherein the audio buffer transmits the audio signal with a time delay.

5. The wireless communication device according to claim 1, wherein the decision handler comprises:
a threshold enable value;
a threshold disable value; and
a probability of speech value,
wherein the probability of speech value is determined from a plurality of values received from the voice activity detector and the switch is placed in a transmit state if the probability of speech value is greater that the threshold enable value and the switch is placed in a non-transmit state if the probability of speech value is less than the threshold disable value.

6. The wireless communication device according to claim 5, wherein the decision handler further comprises:
a weighting factor that is multiplied by each of the values received from the voice activity detector, wherein the weighting factor has a variable value for each value received from the voice activity detector.

7. The wireless communication device according to claim 5, wherein each of the threshold enable value and the threshold disable value has a unique value for each of a transmit state and an idle state 402 of the device.

8. A method for automatically transmitting voice signals with a wireless device, the method comprising:
receiving an audio signal;
buffering the audio signal to form a buffered audio signal;
assigning a probability factor to the audio signal; and
transmitting the buffered audio signal when the probability factor exceeds a threshold enable value.

9. The method according to claim 8, further comprising:
stopping transmission of the buffered audio signal when the probability factor falls below a threshold disable value.

10. The method according to claim 8, wherein the probability factor is a function of a plurality of samples of the audio signal.

11. The method according to claim 8, wherein the probability factor is a summation of products of a variable weighting factor and an output value of a voice activity detector, each product representing a different point-in-time.

12. The method according to claim 11, wherein the variable weighting factor decreases as each point-in-time increases in a temporal distance from a present time.

13. The method according to claim 8, further comprising:
assigning a separate threshold value for each of an idle state, a transmit state, and a listen state representing various operational states.

14. A computer program product for automatically transmitting voice signals with a wireless device, the computer program product comprising:
a storage medium readable by a processing circuit and storing instructions for execution by the processing circuit for performing a method comprising:
receiving an audio signal;
buffering the audio signal to form a buffered audio signal;
assigning a probability factor to the audio signal; and
transmitting the buffered audio signal when the probability factor exceeds a threshold enable value.

15. The computer-implemented method according to claim 14, further comprising:
stopping transmission of the buffered audio signal when the probability factor falls below a threshold disable value.

16. The computer-implemented method according to claim 14, wherein the probability factor is a function of a plurality of samples of the audio signal.

17. The computer-implemented method according to claim 14, wherein the probability factor is a summation of products of a variable weighting factor and an output value of a voice activity detector, each product representing a different point-in-time.

18. The method computer-implemented according to claim 17, wherein the variable weighting factor decreases as each point-in-time increases in a temporal distance from a present time.

19. The computer-implemented method according to claim 14, further comprising: assigning a separate threshold value for each of an idle state, a transmit state, and a listen state representing various operational states.
